(19) United States
(12) Patent Application Publication
(10) Pub. No.: US 2014/0222961 A1
(43) Pub. Date: Aug. 7, 2014

(54) REPRODUCTION APPARATUS, REPRODUCTION METHOD, DISTRIBUTION APPARATUS, DISTRIBUTION SYSTEM, REPRODUCTION PROGRAM, AND STORAGE MEDIUM

(71) Applicant: Maki Takahashi, Osaka-shi (JP)

(72) Inventor: Maki Takahashi, Osaka-shi (JP)

(73) Assignee: SHARP KABUSHIKI KAISHA, Osaka-shi, Osaka (JP)

(21) Appl. No.: 14/343,919

(22) PCT Filed: Sep. 10, 2012
(86) PCT No.: PCT/JP2012/073109

§ 371 Date: Mar. 10, 2014

(30) Foreign Application Priority Data
Sep. 12, 2011 (JP) 2011-198856

(51) Int. Cl. H04L 29/06

(52) U.S. Cl. CPC H04L 65/4076
USPC 709/217

(57) ABSTRACT

A reproduction apparatus (100) includes a streaming control unit (110) configured to acquire a set of contents from N distribution apparatuses, and a reproduction unit (120) configured to reproduce the set of contents. The reproduction unit (120) reads out, for each distribution apparatus, a transmission delay that occurred when transmission from a distribution apparatus was performed by referring to a transmission delay history table (155), and the reproduction unit (120) derives a period with a length depending on the transmission delay. The reproduction unit (120) starts reproducing the set of contents after the contents are buffered for a period equal to the longest one of the derived periods.

### TECHNICAL FIELD

The present invention relates to a reproduction apparatus configured to acquire a set of contents of distribution data via a plurality of transmission routes and a reproduction method therefor. The present invention also relates to a distribution apparatus configured to distribute at least part of distribution data. Furthermore, the present invention relates to a distribution system including the above-described reproduction apparatus, a reproduction program that allows a computer to function as such a reproduction apparatus, and a computer-readable storage medium storing such a reproduction program.

### BACKGROUND ART

Conventionally, moving images and sounds are distributed only via a broadcast network. However, broadband Internet connections have now become popular, and it has become popular to distribute moving images and sounds via the Internet.

In recent years, it has become possible to receive television programs provided by IP retransmission of digital terrestrial broadcasts via NGN (Next Generation Network).

A time lag occurs depending on a transmission delay in a transmission network from transmission of a moving image from a distribution apparatus to reproduction of the moving image by a reproduction apparatus. FIG. 15 is a graph illustrating a distribution of transmission delays in various networks. As can be seen from FIG. 15, the amount of transmission delay that may occur during the transmission varies depending on networks. That is, the amount of a resulting time lag generally varies depending on which network is used to receive a moving image.

Therefore, in a case where a plurality of video images to be synchronously reproduced are distributed via different transmission routes (for example, in a case where one of video images of a two-location live coverage is distributed via one transmission route and another video image is distributed via another transmission route), a reproduction apparatus needs to buffer the respective video images so as to achieve synchronization in reproduction of the plurality of video images.

NPL 1 is a RFC document describing technical specifications on real-time streaming protocol (RTSP). A receiving apparatus supporting RTSP acquires a jitter value from a server using a GET_PARAMETER method defined in NPL 1 and is capable of determining a buffering time depending on the jitter value.

### CITATION LIST

### Non Patent Literature

NPL 1: H. Schulzrinne, A. Rao, and R. Lanphier “Real Time Streaming Protocol (RTSP)”, [online], April, 1998, retrieved Jul. 20, 2011 from the Internet site <http://www.ietf.org/rfc/rfc2326.txt>

### SUMMARY OF INVENTION

### Technical Problem

However, in the conventional technique described above, in a case where a plurality of video images to be synchronously reproduced are distributed via different transmission routes, it is not easy to immediately determine a buffering time optimum for synchronously reproducing the plurality of video images.

In view of the problem described above, a main purpose of the present invention is to realize a reproduction apparatus capable of quickly starting reproducing a program in a case where a set of contents to be synchronously reproduced for the program (more generally, distribution data) are acquired via a plurality of transmission routes.

### Solution to Problem

To solve the above-described problem, the present invention provides a reproduction apparatus including acquisition means that acquires a set of pieces of component data distributed from respective ones of a plurality of distribution apparatuses, the pieces of component data being components of distribution data and being to be synchronously reproduced, referring means that refers, for each one of the plurality of distribution apparatuses, to a delay time that occurred when component data was acquired in the past from the distribution apparatuses, the delay time being stored in a storage medium as a history of the distribution apparatuses, derivation means that derives, for each of the plurality of distribution apparatuses, a buffering period necessary in reproducing component data acquired from the distribution apparatus such that the buffering period has a length corresponding to a magnitude of the delay time stored as the history of the distribution apparatus and referred to by the referring means, reproduction means that reproduces the distribution data after component data being acquired from each one of the plurality of distribution apparatuses has been buffered for a particular period, and setting means that sets the particular period so as to be equal to a greatest one of the buffering periods derived by the derivation means.

In the above-described aspect of the reproduction apparatus according to the present invention, the reproduction means starts reproducing the program after the set of pieces of component data (for example, set of contents of components) has been buffered for the period with the length corresponding to the longest delay time, such that it is possible to synchronously reproduce the set of pieces of component data by performing the buffering for the period with the minimum necessary length. Furthermore, because the reproduction means determines the buffering time by referring to the transmission delay stored as the history in the storage medium of the reproduction apparatus, it is possible to more quickly determine the buffering time than is possible by the conventional technique.

Thus in a distribution system in which a set of contents of a program are distributed via a plurality of transmission routes, the reproduction apparatus is capable of starting reproducing the program in such a manner that synchronization among contents is achieved.

To solve the above-described problem, the present invention provides a reproduction method including acquiring a set of pieces of component data distributed from respective ones of a plurality of distribution apparatuses, the pieces of component data being components of distribution data and being to be synchronously reproduced, referring, for each one of the plurality of distribution apparatuses, to a delay time that occurred when component data was acquired in the past from the distribution apparatus, the delay time being stored in a storage medium as a history of the distribution apparatus, deriving, for each of the plurality of distribution apparatuses, a buffering period necessary in reproducing component data acquired from the distribution apparatus such that the buffering period has a length corresponding to a magnitude of the delay time stored as the history of the distribution apparatus and referred to, reproducing the distribution data after a content being acquired from each one of the plurality of distribution apparatuses has been buffered for a particular period, and setting the particular period so as to be equal to a greatest one of the derived buffering periods.

In the aspect described above, the reproduction method according to the present invention provides advantageous effects similar to those provided by the reproduction apparatus according to the present invention.

### Advantageous Effects of Invention

As described above, the reproduction apparatus according to the present invention has an advantage that it is possible to quickly start reproducing a program in a case where a set of contents of a program (more generally, distribution data) to be synchronously reproduced are acquired via a plurality of transmission routes.

### BRIEF DESCRIPTION OF DRAWINGS

FIG. 1 is a diagram illustrating a configuration of a distribution system and a reproduction apparatus included in the distribution system according to an embodiment of the invention.

FIG. 2 is a diagram schematically illustrating locations at which contents are displayed on a screen of a display apparatus.

FIG. 3 is a flow chart illustrating an example of an operation performed before the reproduction apparatus illustrated in FIG. 1 starts reproducing a program.

FIG. 4 is a diagram illustrating, in the form of a graph of a distribution curve of a transmission delay, an allowable buffering time set in the case where the reproduction apparatus illustrated in FIG. 1 performs the operation illustrated in the flow chart of FIG. 3.

FIG. 5 is a diagram illustrating a graph drawn to represent distribution curves of transmission delays and also illustrating allowable buffering times calculated by the reproduction apparatus illustrated in FIG. 1 in performing the operations of the flow charts illustrated in FIG. 3, FIG. 6, and FIG. 8.

FIG. 6 is a flow chart illustrating an example of an operation performed before the reproduction apparatus illustrated in FIG. 1 starts reproducing a program.

FIG. 7 is a diagram illustrating a graph of a distribution curve of a transmission delay and an allowable buffering time set by the reproduction apparatus illustrated in FIG. 1 in performs the operation of the flow chart illustrated in FIG. 6.

FIG. 8 is a flow chart illustrating an example of an operation performed by the reproduction apparatus illustrated in FIG. 1 to reproduce a video content capable of being reproduced in a multi-angle mode.

FIG. 9 is a diagram schematically illustrating timings of staring reproducing respective packages described later and a reproduction speed in a case where the reproduction apparatus illustrated in FIG. 1 performs the operation of the flow chart illustrated in FIG. 8.

FIG. 10 is a diagram illustrating a configuration of a distribution system and a reproduction apparatus included in the distribution system according to another embodiment of the invention.

FIG. 11 is a diagram schematically illustrating a correspondence relationship among descriptors referred to by the reproduction apparatus illustrated in FIG. 10.

FIG. 12 is a diagram illustrating part of contents of a component descriptor and contents of a content descriptor, where (a) illustrates contents of the component descriptor and (b) illustrates contents of the content descriptor.

FIG. 13 is a diagram illustrating two examples (a) and (b) of contents of package descriptors where some parts of the contents are not illustrated.

FIG. 14 is a diagram illustrating part of contents of a package descriptor in which (a) illustrates a range of values allowed to be taken by NW identifiers, and (b) illustrating history information in terms of transmission delays described for each NW identifier (or a combination of a broadcast station and a NW identifier).

FIG. 15 is a diagram illustrating a graph of distribution curves in terms of transmission delays for respective types of transmission networks.

### DESCRIPTION OF EMBODIMENTS

### First Embodiment

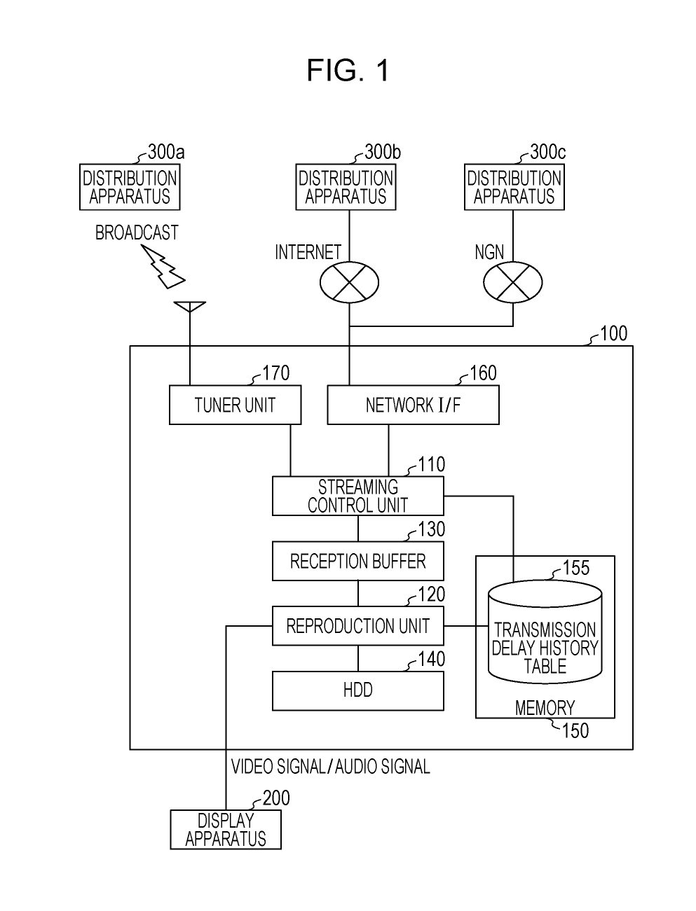

A distribution system according to a first embodiment is described with reference to FIG. 1 to FIG. 9.

The distribution system according to the embodiment of the present invention is a distribution system configured to distribute a program containing a plurality of contents (component data) to a reproduction apparatus using three distribution apparatuses. The three distribution apparatuses include a distribution apparatus configured to distribute a content via a broadcast network, a distribution apparatus configured to distribute a content via an Internet network, and a distribution apparatus configured to distribute a content via a NGN network.

Each program includes a content essentially required to be reproduced and a content that may or may not be reproduced. Note that each program includes at least one content essentially required to be reproduced.

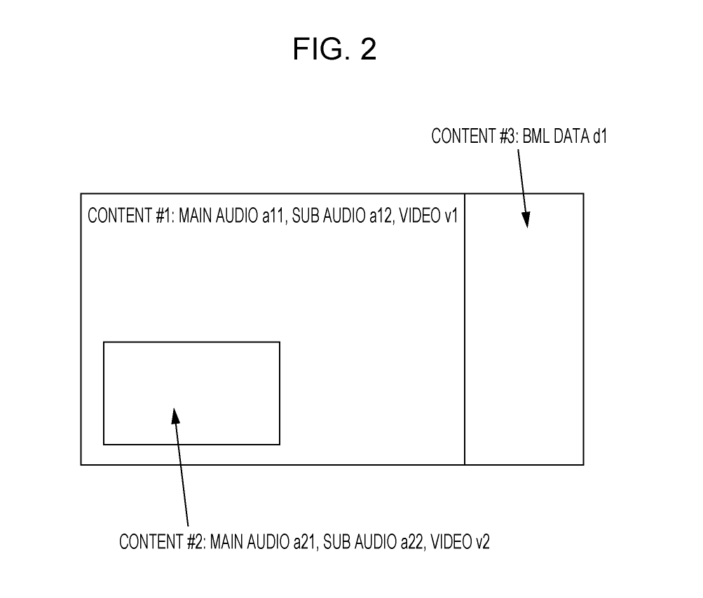

An example of a “program containing a plurality of contents” is a two-location live coverage program containing a main video content essentially required to be reproduced, a video content that may or may not be reproduced, and a BML content. FIG. 2 illustrates a screen configuration for a two-location live coverage program displayed on a screen of a display apparatus. In FIG. 2, “content #1” denotes a main video content, “content #2” denotes a sub video content, and “content #3” denotes a BML content.

Each content includes one or more components (component data) such as a video image, a sound, a sub title, software, an advertisement, or the like. By performing scalable coding on a video image, it is allowed to produce layers (a basic layer, an extended layer #1, an extended layer #2, . . . ) as different components. As for sounds, it is possible to produce a main sound and a sub sound as different components. Note that each content essentially required to be reproduced includes at least one component essentially required to be reproduced, and any content optional as to whether to be reproduced includes no component that is essentially required to be reproduced. A component that may or may not be reproduced may be included in either a content essentially required to be reproduced or an optional content. In the example illustrated in FIG. 2, a content #1 includes a main sound component a11 (optional as to whether to be reproduced), a sub sound component a12 (optional as to whether to be reproduced), and a video image component v1 (essentially required to be reproduced), and a content #2 includes a main sound component a21 (optional as to whether to be reproduced), a sub sound component a22 (optional as to whether to be reproduced), and a video image component (optional as to whether to be reproduced). Furthermore, in the example illustrated in FIG. 2, a BML content (content #3) includes BML data d1 (optional as to whether to be reproduced) as only one component.

In the distribution system according to the present embodiment, when the reproduction apparatus receives a program reproduction command, the reproduction apparatus starts reproducing a content, of a program, essentially required to be reproduced.

The reproduction apparatus also starts reproducing a content optional as to whether to be reproduced in the program in a case where the content is specified to be reproduced.

It is allowed to set the reproduction apparatus either such that all components in a content to be reproduced are reproduced or such that only one or more components selected by user are reproduced. As for each content essentially required to be reproduced, at least one or more of all components included in the content are specified as being essentially required to be reproduced, and the reproduction apparatus reproduces these components regardless of whether or not they are selected by a user.

FIG. 1 is a diagram illustrating a configuration of a distribution system and a configuration of a reproduction apparatus included in the distribution system according to the present embodiment of the invention.

As illustrated in FIG. 1, the distribution system according to the present embodiment includes a reproduction apparatus 100, a display apparatus 200, and three distribution apparatuses 300a to 300c.

Furthermore, in the distribution system, as illustrated in FIG. 1, the reproduction apparatus 100 determines a set of components to be reproduced from a set of contents in a program to be reproduced, and acquires the components to be reproduced from the distribution apparatuses 300a to 300c that provide the respective components in the determined set of components. Note that each of distribution apparatuses 300a to 300c is configured to distribute components not individually but in units called packages in which a plurality of components are multiplexed. Therefore, the reproduction apparatus 100 performs the reproduction by acquiring packages including the components to be reproduced in the above-described set of components from the distribution apparatuses corresponding to the respective packages. Note that information associated with each package (for example, information indicating a configuration of each component in the package, access information indicating a distribution apparatus to which to access) may be received, for example, from a particular distribution apparatus whose access destination information is known when the program reproduction command is received.

Next, the reproduction apparatus 100, the display apparatus 200, and the distribution apparatuses 300a to 300c are described below.

(Distribution Apparatus 300a)

The distribution apparatus 300a is a distribution apparatus configured to distribute components in packages via a broadcast network such that the reproduction apparatus 100 is allowed to receive components to be reproduced.

(Distribution Apparatus 300b)

The distribution apparatus 300b is a distribution apparatus configured to distribute components in packages via an Internet network such that the reproduction apparatus 100 is allowed to receive components to be reproduced.

(Distribution Apparatus 300c)

The distribution apparatus 300c is a distribution apparatus configured to distribute components in packages via a NGN networks such that the reproduction apparatus 100 is allowed to receive components to be reproduced.

(Reproduction Apparatus 100)

As illustrated in FIG. 1, the reproduction apparatus 100 includes a streaming control unit 110, a reproduction unit 120, a reception buffer 130, a HDD (hard disk drive) 140, a nonvolatile memory 150, a network I/F 160, and a tuner unit 170.

(Streaming Control Unit 110)

The streaming control unit 110 controls the network I/F 160 and the tuner unit 170 to acquire packages including components to be reproduced from corresponding one or more of distribution apparatuses 300a to 300c based on information associated with the package, and buffers the components included in each package in the reception buffer 130.

When reproducing the program to be reproduced is started, the streaming control unit 110 determines the difference between a reception time at which the package is received from one of the distribution apparatuses 300a to 300c and a time stamp (distribution time) described in the package (hereinafter, the term “transmission delay” will be used in this meaning), and stores the resultant difference as a transmission delay in the transmission delay history table 155 in the nonvolatile memory 150. Note that the transmission delay may be stored for all packets in transmission units (for example, in units of IP packets or TS packets) of packages transmitted via a network between the reproduction apparatus 100 and a distribution apparatus (one of distribution apparatuses 300a to 300c), or the transmission delay may be stored in every particular period for only packets, of all packets, received by a particular point of time in each period.

(Reproduction Unit 120)

The reproduction unit 120 refers to the transmission delay history table 155 and determines a buffering period before reproducing of each component is started. When the above-described period has elapsed after the start of buffering, the reproduction unit 120 sequentially reproduces data of the components buffered in the reception buffer 130. A video signal and an audio signal obtained via the reproduction are supplied to the display apparatus 200 via a HDMI cable or the like which is not illustrated in the figure.

(Reception Buffer 130)

The reception buffer 130 is a buffer configured to buffer data of each component received from distribution apparatuses.

(HDD 140)

The HDD 140 is a storage medium configured to store each component in a case where a program is recorded.

(Nonvolatile Memory 150)

The nonvolatile memory 150 is a flash memory configured to store the transmission delay history table 155.

(Network I/F 160)

The network I/F 160 is a network I/F for receiving packages from the distribution apparatuses 300b and 300c.

(Tuner Unit 170)

The tuner unit 170 is a tuner for receiving a broadcast wave carrying the packages distributed the distribution apparatus 300a.

(Display Apparatus 200)

The display apparatus 200 displays on a screen a video image represented by a video signal supplied from the reproduction apparatus 100 and outputs from a speaker a sound represented by an audio signal supplied from the reproduction apparatus 100.

(First Example of Operation of Reproduction Apparatus 100)

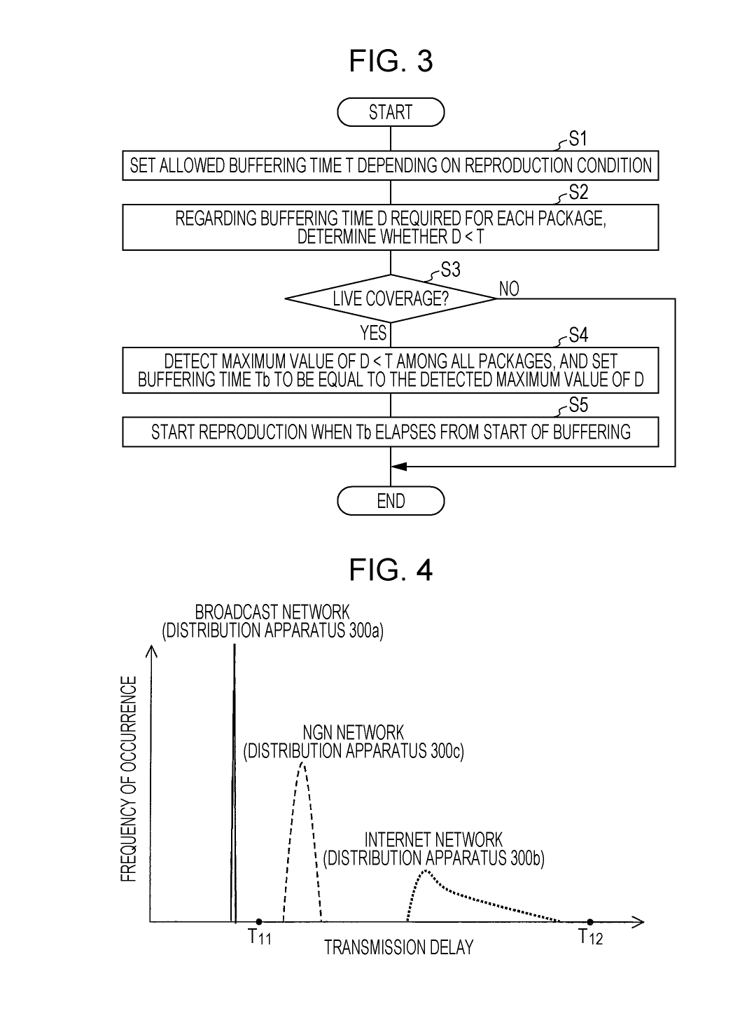

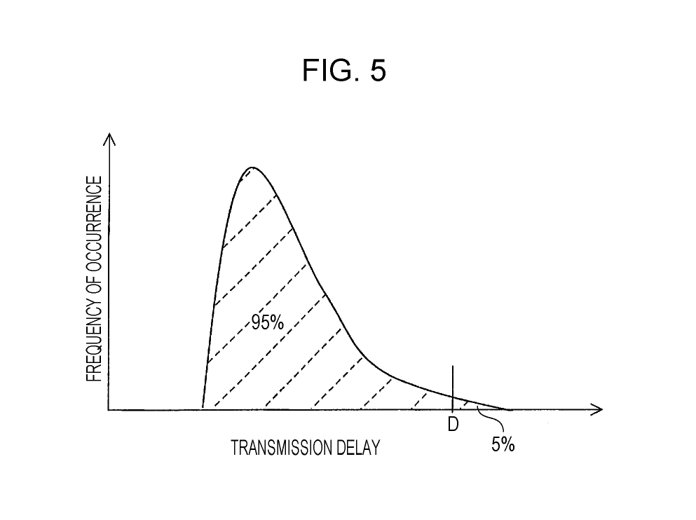

Next, an example of an operation of the reproduction apparatus according to the present embodiment is described below with reference to FIG. 3 to FIG. 5. FIG. 3 is a flow chart illustrating an example of an operation performed by the reproduction apparatus 100 before reproducing of a program to be reproduced is started. FIG. 4 is a diagram in which a graph is drawn in a coordinate plane to represent distribution curves of transmission delays that occur when packages are acquired from the respective distribution apparatuses, and an example is illustrated as to an allowable buffering time set by the reproduction apparatus 100 when performing the above-described operation. FIG. 5 is a diagram in which a graph is drawn in a coordinate plane to represent distribution curves of transmission delays that occur when packages are acquired from the distribution apparatuses, and an example of a necessary buffering time set by the reproduction apparatus 100 for each corresponding package is represented.

Note that in the present embodiment it is assumed that packages including components essentially required to be reproduced are distributed from the distribution apparatus 300a via a broadcast network generally having a smallest transmission delay. For example, in a case where a program to be reproduced includes one video content essentially required to be reproduced, and this video content is scalable-coded components including a video image component (essentially required to be reproduced), which is a HD video image, in the basic layer and a video image component (optional as to whether to be reproduced), that is a 4K video image, in the extended layer, where the package #1 is formed only by the video image component in the basic layer, and the package #2 is formed only by the video image component in the extended layer, then the package #1 is distributed from the distribution apparatus 300a, and the package #2 is distributed from either one of the distribution apparatuses 300b and 300c.

As illustrated in FIG. 3, the reproduction apparatus 100 sets an allowable buffering time T (particular allowable time) to a value predetermined depending on a reproduction condition (as to whether to reproduce a live coverage program or a recorded program) (S1). For example, as illustrated in FIG. 4, the reproduction unit 120 sets T to a value of T₁₁ for the live coverage program reproduction and T₁₂ for the recorded program reproduction.

After step S1, the reproduction unit 120 makes a determination, in terms of the necessary buffering time D for each package including at least part of a set of components to be reproduced, as to whether or not D<T is satisfied (S2). More specifically, the reproduction unit 120 determines the necessary buffering time D for each package depending on a delay time that occurred when the package was acquired in the past from a distribution apparatus corresponding to the package. The necessary buffering time D may be determined to be equal to a maximum delay time recorded in a corresponding record in the transmission delay history table 155. However, in this case, there may be a problem that the necessary buffering time is set to be large when the transmission delay of a network has a large fluctuation as with the case of the Internet. In the case of video contents, even when a partial data loss occurs due to a transmission error or for other reasons, an influence on reproduction is generally very small. For example, in a case where an allowable error rate for the content is 5%, even when a data loss less than 5% occurs during a particular period, it is possible to maintain the reproduction quality for the content to be higher than predetermined reproduction quality. In this case, for example, as illustrated in FIG. 5, the necessary buffering time D may be set to be equal to a delay time corresponding to an entry at a 5% location below the greatest delay time recorded in the corresponding record of the transmission delay history table 155. By making the setting in such a manner, it becomes possible for the reproduction apparatus 100 to, in reproducing the package, complete the reception of 95% of data during a buffering period set based on the necessary buffering time D before the reproduction is started, and it is expected to maintain the particular reproduction quality even if the reproduction is performed without waiting for the reception of the remaining 5% of data to be completed and thus without using the 5% of data. Alternatively, the reproduction unit 120 may randomly select 100 pieces of values of the delay time from a sufficiently large number of pieces of values recorded in the corresponding record of the transmission delay history table 155 and may employ a 5th greatest value of the delay time as D thereby achieving a similar advantageous effect. The reproduction unit 120 then determines whether or not D<T is satisfied for each D determined in the above-described manner.

After step S2, in a case where the reproduction condition is not for the live coverage program (NO in S3), the reproduction unit 120 starts a recording process for each content. After the recording is completed, reproducing is started and the process is ended. On the other hand, in a case where the reproduction condition is for the live coverage program (YES in S3), the processing flow proceeds to S4.

In step S4, the reproduction unit 120 sets a buffering time Tb (particular period) to be equal to a maximum value of the necessary buffering times D satisfying D<T for the packages. In a case where the reproduction mode is the live coverage program reproduction mode, only the package #1 corresponding to the distribution apparatus 300a satisfies D<T (=T₁₁), and thus the reproduction unit 120 sets the buffering time Tb to be equal to D of the package #1.

After step S4, the streaming control unit 110 acquires packages including components to be reproduced from the respective distribution apparatuses and sequentially buffers the acquired packages in the reception buffer 130. After Tb has elapsed from the start of the buffering, reproducing of the buffered components is started (S5), and the process is ended.

The first example of the operation of the reproduction apparatus 100 has been described above. Note that the necessary buffering time D set in step S2 for each package is a value that allows the reproduction apparatus 100 to start reproducing components included in the package after performing buffering for a period equal to the necessary buffering time D defined for the package.

Because the buffering time Tb during which buffering is performed before the reproduction apparatus 100 starts the reproduction is equal to the maximum value of D satisfying D<T, the value of the buffering time Tb is close to a minimum value needed to reproduce the set of components (set of contents) while maintaining synchronization among the components (the contents). Furthermore, because the reproduction apparatus 100 determines the buffering time Tb by referring to the transmission delay history table 155, it is possible to quickly determine the buffering time Tb.

Thus, the reproduction apparatus 100 is capable of quickly starting the reproduction while maintaining synchronization among the components (the contents) by using the minimum necessary buffering time.

(Second Example of Operation of Reproduction Apparatus 100)

Depending on a configuration of a program, there is a possibility that a plurality of contents or components are exclusively reproduced in accordance with an operation by a user. For example, this may occur when a multi-angle a program is reproduced in a selected angle by selecting a corresponding one of video image contents or when a multi-language program is reproduced in a selected language by selecting a corresponding one of audio components or sub title components.

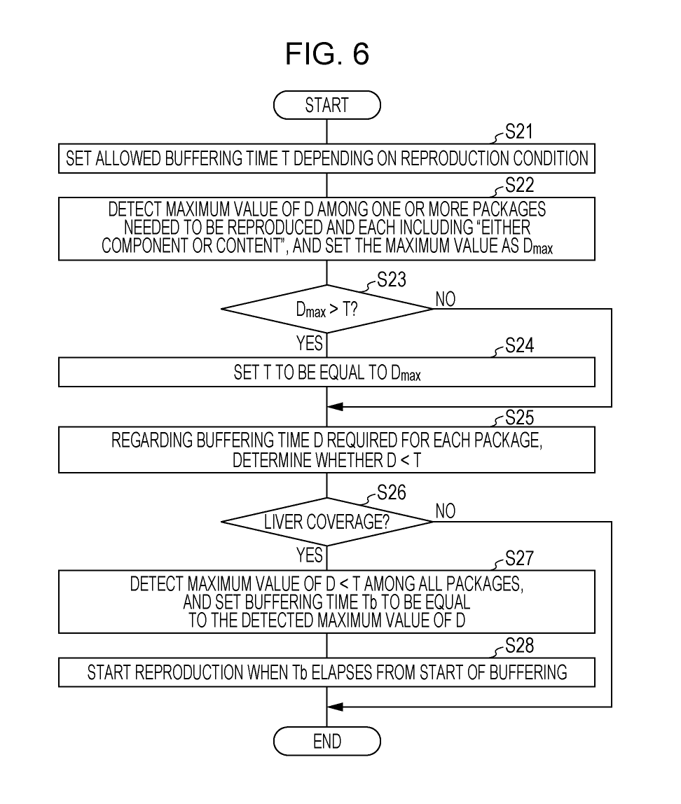

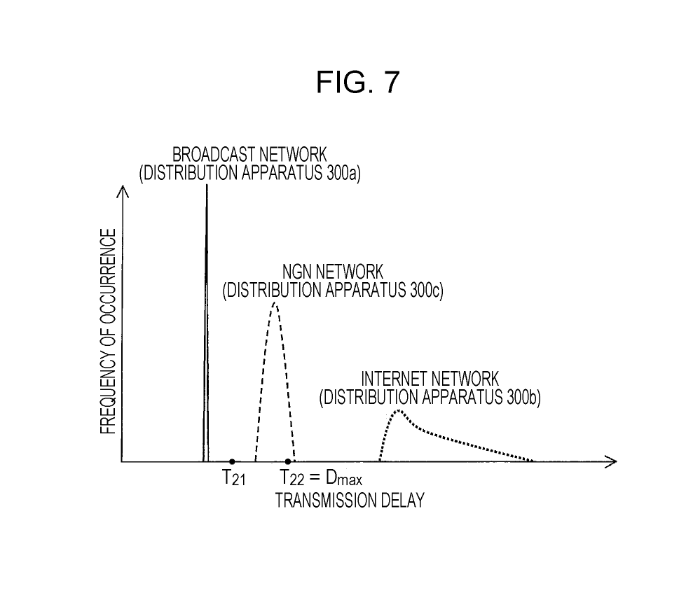

An example of an operation performed in such a manner is described below with reference to FIG. 6 and FIG. 7. FIG. 6 is a flow chart illustrating an example of an operation performed by the reproduction apparatus 100 before starting reproducing a program. FIG. 7 is a diagram in which a graph is drawn in a coordinate plane to represent distribution curves of transmission delays that occur when packages are acquired from the respective distribution apparatuses, and an example is illustrated as to an allowable buffering time set by the reproduction apparatus 100 when performing the above-described operation.

Note that in the present example of the operation, at the point of time when a program is distributed, it is not clearly defined as to whether contents or components of the program are ones necessary required to be reproduced or optional as to whether to be reproduced. When the program is reproduced, a user defines whether the contents or the components are ones necessary required to be reproduced or optional as to whether to be reproduced. In the following description, it is assumed by way of example that a multi-angle program including three types of video contents respectively corresponding to viewing points #1 to #3 is provided using packages #1 to #3 for each content, and the video contents are respectively distributed from the distribution apparatuses 300a to 300c.

As illustrated in FIG. 6, the reproduction unit 120, as in S1 of the first example of the operation, sets an allowable buffering time T (particular allowable time) to a value predetermined depending on the reproduction condition (whether a liver coverage program or a recorded program is reproduced) (S21). For example, the reproduction unit 120 sets the value of the allowable buffering time T to T₂₁ illustrated in FIG. 7.

After step S21, the reproduction unit 120 defines the value of Dₘₐₓ so as to be equal to a maximum value of D among necessary buffering times D for packages each including at least part of a set of components specified as ones necessary required to be reproduced (S22). In the example illustrated in FIG. 7, Dₘₐₓ is determined for a case where a user selects the package #2 (the video content of the viewing point #2) distributed from the distribution apparatus 300c.

After step S22, the reproduction unit 120 determines whether or not Dₘₐₓ>T is satisfied (S23). In a case where the determination is that Dₘₐₓ>T is satisfied (YES in S23), the value of T is set to be equal to Dₘₐₓ (S24), and the processing flow proceeds to S25. In the example described above, the allowable buffering time T₂₁<Dₘₐₓ, and thus the value of T is set to T₂₂ (=Dₘₐₓ). On the other hand, in a case where the determination is that Dₘₐₓ>T is not satisfied (YES in S23), the processing flow proceeds to S25.

The process in S25 to S28 is similar to that in S2 to S5, and thus a further description thereof is omitted.

In the second example of the operation, as described above, even when the predetermined allowable buffering time T is small, the reproduction apparatus 100 may change the allowable buffering time T to a greater value thereby making it possible to start reproducing the components essentially required to be reproduced. That is, regardless of the magnitude of the allowable buffering time T, the reproduction apparatus 100 is capable of surely reproducing a video content with a viewing point #2 selected by a user with a minimum buffering delay.

(Third Example of Operation of Reproduction Apparatus 100)

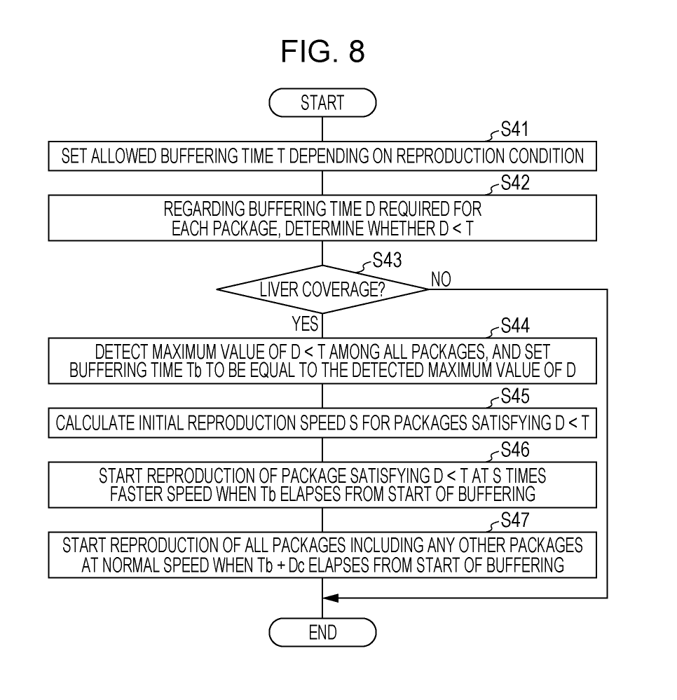

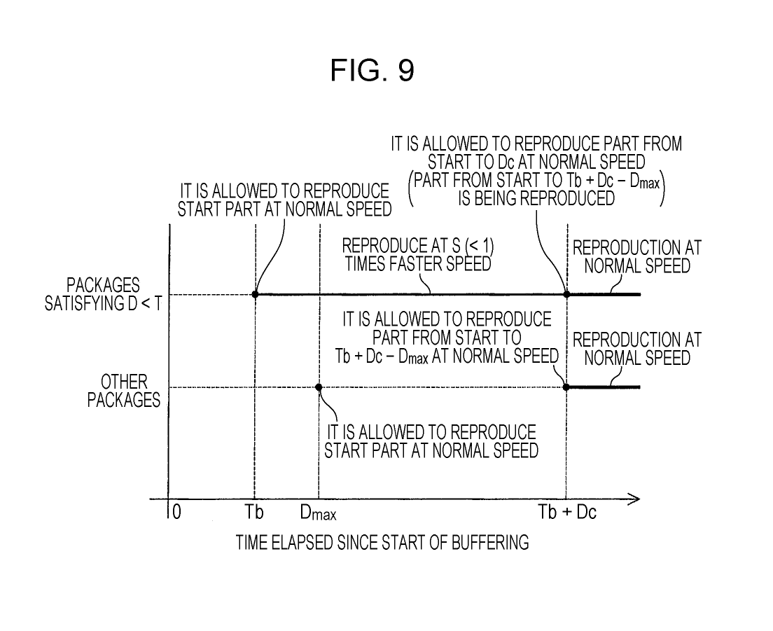

Still another example of an operation of the reproduction apparatus according to the present embodiment is described below with reference to FIG. 4, FIG. 8, and FIG. 9. FIG. 8 is a flow chart illustrating an example of an operation performed by the reproduction apparatus 100 to reproduce a video content. FIG. 9 is a diagram schematically illustrating a manner in which the reproduction apparatus 100 performs a reproduction process starting from buffering of components included in a package for both cases where the package satisfies D<T and where the package does not satisfy D<T.

In the present example of the operation, regardless of the magnitude of the allowable buffering time T, all packages (that is, all contents and all components) of a program are acquired from a distribution apparatus and reproduced. The operation is performed in this manner, for example, in a case where a program of interest includes scalable-coded video contents, and a package #1 including a HD video image component in the basic layer is acquired from the distribution apparatus 300a via a broadcast network and a package #2 including a 4K video image component in the extended layer is acquired from the distribution apparatus 300b via a NGN network.

The reproduction unit 120, as illustrated in FIG. 8, as in S1 of the first example of the operation, sets an allowable buffering time T (particular allowable time) to a value predetermined depending on a reproduction condition (as to whether to reproduce a live coverage program or a recorded program) (S41). The reproduction unit 120 sets the value of the allowable buffering time T, for example, to T₁₁ illustrated in FIG. 4.

After step S41, the reproduction unit 120 makes a determination in terms of the necessary buffering time D for each package to be reproduced as to whether or not D<T is satisfied (S42). In the example described above, the reproduction unit 120 determines that D<T (=T₁₁) is satisfied for D of the package #1 while D<T (=T₁₁) is not satisfied for D of the package #2.

After step S42, in a case where the reproduction condition is not for a live coverage program (NO in S42), the reproduction unit 120 starts a recording process for each content. After the recording is completed, reproducing is started and the process is ended. On the other hand, in a case where the reproduction condition is for a live coverage program (YES in S42), and the processing flow proceeds to S44.

In step S44, as in step S4, the reproduction unit 120 sets a buffering time Tb to be equal to a maximum value of the necessary buffering times D satisfying D<T for the packages. In the example described above, the value of the buffering time Tb is set to be equal to D of the package #1.

After step S44, the reproduction unit 120 calculates an initial reproduction speed S for packages satisfying D<T (S45). More specifically, the reproduction unit 120 calculates S according to an equation: the initial reproduction speed S=1−(Dₘₐₓ−Tb)/D_{c}. In this equation, D_{c} denotes a period in which each component in packages satisfying D<T is reproduced at a speed S (<1) times a normal speed, wherein D_{c} is preset in the reproduction apparatus 100. On the other hand, Dₘₐₓ has a value equal to a greatest value of D among necessary buffering times D for the packages to be reproduced.

After step S45, the streaming control unit 110 acquires components to be reproduced from the distribution apparatuses 300a and 300b and sequentially buffers the acquired components in the reception buffer 130. After Tb has elapsed from the start of the buffering, the reproduction unit 120 starts reproducing particular components of the components being buffered that are included in packages satisfying D<T at the speed S times the normal speed (S46). In the example described above, after Tb has elapsed from the start of the buffering, the reproduction unit 120 starts reproducing the HD video image included in the package #1 at the speed S times the normal speed.

At a point of time when the period D_{c} has further elapsed from the start of the reproduction at the speed S times the normal speed in step S46, the reproduction unit 120 starts reproducing the other components (components included in packages that do not satisfying D<T) in a normal mode. Note that at this point of time, the reproduction unit 120 switching the reproduction mode into the normal mode also for the components that have been reproduced at the speed S times the normal speed (S47). In the example described above, when Tb+D_{c} has elapsed from the start of the buffering, the reproduction unit 120 starts reproducing the HD video image included in the package #1 and the 4K video image included in the package #2 at the speed 1 times the normal speed.

The third example of the operation of the reproduction apparatus 100 has been described above. FIG. 9 illustrates a manner in which the reproduction apparatus 100 reproduces a program according to the third example of the operation.

As illustrated in FIG. 9, at a point of time when Dₘₐₓ has elapsed after the start of buffering, the reproduction apparatus 100 comes into a state in which it is allowed to reproduce an initial part of each component of packages that do not satisfy D<T. However, at this point of time, the reproduction apparatus 100 is reproducing a part at a location apart by S×(Dₘₐₓ−Tb) from the beginning of each component of packages satisfying D<T. Therefore, if reproducing of the packages that do not satisfying D<T are started at this point of time, synchronization with the packages satisfying D<T is not achieved in the reproduction.

Thus, in the third example of the operation, the reproduction apparatus 100 starts reproducing all packages at the point of time when (Tb+D_{c}) has elapsed from the start of the buffering. At this point of time, the reproduction apparatus 100 is reproducing a part that is apart by S×D_{c}=Tb+D_{c}−Dₘₐₓ from the beginning of each component of packages satisfying D<T as illustrated in FIG. 9. At this point of time, also for packages that do not satisfy D<T, it is allowed to reproduce a part that is apart by Tb+D_{c}−Dₘₐₓ from the beginning of each component. Thus, at the point of time when (Tb+D_{c}) has elapsed from the start of the buffering, if reproducing of packages that do not satisfy D<T is started from a part that is apart by Tb+D_{c}−Dₘₐₓ from the beginning of each component, and the reproduction speed for the packages satisfying D<T is changed from the speed S times the normal speed to the normal speed (the speed 1 times the normal speed), then it becomes possible to reproduce all packages in a manner in which synchronization is achieved.

In the present example of the operation, as described above, as for components (contents) that are allowed to be reproduced with buffering in the allowable buffering time T, the reproduction apparatus 100 preferentially starts the reproduction while maintaining the synchronization. At a particular point of time thereafter, the reproduction apparatus 100 is allowed to start reproduction of all components (contents) of the program while maintaining the synchronization.

(Advantages of Reproduction Apparatus 100)

As described above, the streaming control unit 110 of the reproduction apparatus 100 acquires a set of components of a program to be reproduced in the synchronous manner such that particular components thereof are acquired from particular distribution apparatuses that provide the particular components.

The reproduction unit 120 of the reproduction apparatus 100 refers to the transmission delay history table 155 in the memory 150 disposed in the reproduction apparatus 100 to retrieve a transmission delay, for each distribution apparatus, recorded therein that occurred when a component was acquired from the distribution apparatus.

From values of transmission delays that actually occurred in the past for packages distributed from the respective distribution apparatuses, the reproduction unit 120 derives a minimum buffering time necessary to reproduce streaming data.

The reproduction unit 120 buffers a set of components for a period equal to the buffering time. Thereafter, the reproduction unit 120 starts reproducing a program.

Because the reproduction unit 120 starts reproducing a program after buffering a set of components for a period with a length minimally required to reproduce streaming data, the reproduction unit 120 is capable of synchronously reproducing the components. Furthermore, because the reproduction unit 120 determines the buffering time by referring to the transmission delay history table 155 in the memory 150 disposed in the reproduction apparatus 100, it is possible to quickly determine the buffering time compared with the conventional technique.

Thus in the distribution system configured to distribute a set of contents of a program via a plurality of transmission routes as in the case with the distribution system according to the present embodiment, the reproduction apparatus 100 is capable of quickly starting reproducing the program in a manner in which synchronization among contents is achieved.

### Second Embodiment

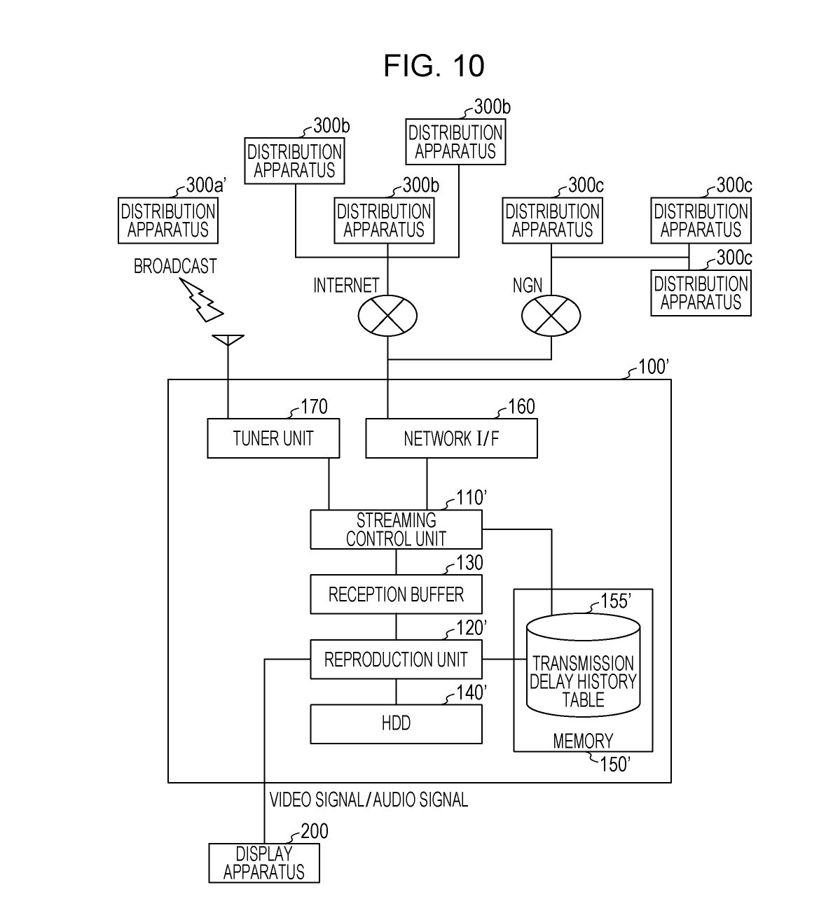

A distribution system according to another embodiment of the present invention is described below with reference to FIG. 10 to FIG. 14. FIG. 10 is a diagram illustrating a configuration of a distribution system and a configuration of a reproduction apparatus included in the distribution system according to the present embodiment.

Unlike the distribution system according to the first embodiment, the distribution system according to the present embodiment includes not only three distribution apparatuses but many distribution apparatuses. More specifically, as illustrated in FIG. 10, the distribution system according to the present embodiment is a content delivery network (CDN) distribution system including a distribution apparatus 300a′ configured to distribute a package via a broadcast network, a plurality of distribution apparatuses 300b each configured to distribute a package via an Internet network, and a plurality of distribution apparatuses 300c each configured to distribute a package via a NGN networks.

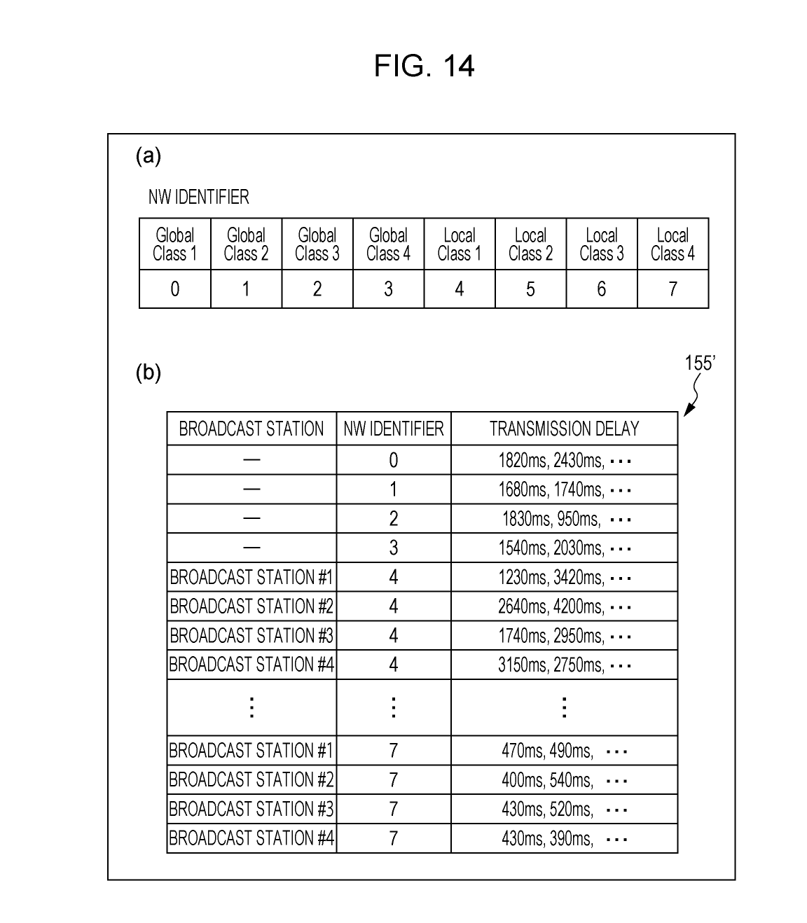

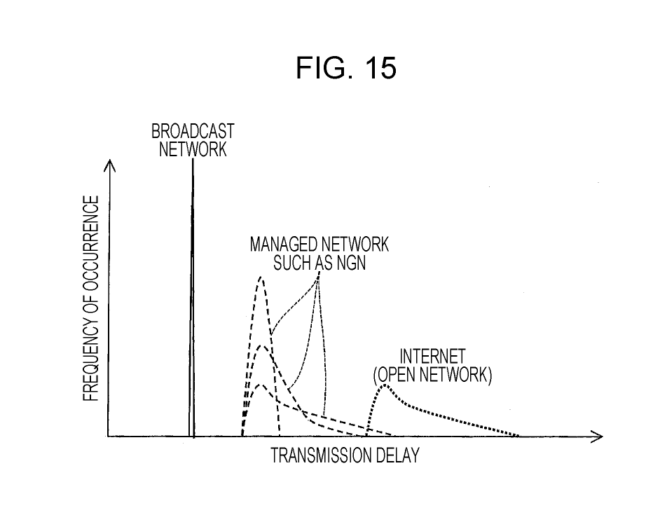

Furthermore, in the distribution system according to the present embodiment, unlike the distribution system according to the first embodiment, the reproduction apparatus 100 stores transmission delays that occur when packages are acquired from distribution apparatuses not for each distribution apparatus but for each group. In the present embodiment, each distribution apparatus belongs to one of groups: a group including one distribution apparatus 300a′; a group including a plurality of distribution apparatuses 300b; or a group including a plurality of distribution apparatuses 300c. Note that in the present embodiment, each group is identified using a network identifier (NW identifier), which will be described later with reference to FIG. 14.

A configuration of the reproduction apparatus 100′ and the distribution apparatus 300a′ according to the present invention are described below with reference to FIG. 10. The distribution apparatus 300b, the distribution apparatus 300c, and the display apparatus 200 are described above in the first embodiment, and thus a further description thereof is omitted.

As illustrated in FIG. 10, the reproduction apparatus 100′ includes a streaming control unit 110′, a reproduction unit 120′, a reception buffer 130, a HDD (hard disk drive) 140, a nonvolatile memory 150, a network I/F 160, and a tuner unit 170.

The streaming control unit 110′, the reproduction unit 120′, and the nonvolatile memory 150′ are described below. Note that the reception buffer 130, the HDD (hard disk drive) 140, the network I/F 160, and the tuner unit 170 are similar in configuration to those according to the first embodiment, and thus a further description thereof is omitted.

(Streaming Control Unit 110′)

When the streaming control unit 110′ receives a program reproduction command, the streaming control unit 110′ accesses the memory 150′ to refer to meta-information (a program descriptor, a content descriptor, a component descriptor, and a package descriptor) needed to reproduce the program. Note that during a period in which the tuner unit 170 receives a broadcast wave, the reproduction apparatus 100′ acquires the meta-information associated with various programs and stores it in the memory 150′.

Based on the meta-information referred to, the streaming control unit 110′ controls the network I/F 160 and the tuner unit 170 such that as for packages including components of a set of contents to be reproduced, the components thereof are acquired from one of many distribution apparatuses, and data of components to be reproduced included in the received packages is buffered in the reception buffer 130.

Furthermore, the streaming control unit 110′ records, in the transmission delay history table 155′ in the nonvolatile memory 150′, a transmission delay that occurs when a package is received from a distribution apparatus for each distribution apparatus during the process of receiving the program to be reproduced. More specifically, the streaming control unit 110′ records transmission delays such that transmission delays of different groups of distribution apparatuses are described in different records of the transmission delay history table 155′. Note that the transmission delay may be recorded for all packets in transmission units (for example, in units of IP packets or TS packets) of packages transmitted via a network between the reproduction apparatus 100′ and a distribution apparatus (one of distribution apparatuses 300a to 300c), or the transmission delay may be recorded in every particular period for only packets, of all packets, received by a particular point of time in each period.

(Reproduction Unit 120′)

The reproduction unit 120′ refers to the transmission delay history table 155′ and determines a buffering period needed before a program to be reproduced is reproduced. After the period described above has elapsed from the start of the buffering, the reproduction unit 120′ sequentially reproduces data of the components buffered in the reception buffer 130. A video signal and an audio signal obtained via the reproduction are supplied to the display apparatus 200 via a HDMI cable or the like which is not illustrated in the figure.

(Nonvolatile Memory 150′)

The nonvolatile memory 150′ is a flash memory configured to store the transmission delay history table 155′.

(Distribution Apparatus 300a′)

The distribution apparatus 300a′ is a distribution apparatus configured to distribute components in packages using a broadcast wave via a broadcast network such that the reproduction apparatus 100 is allowed to receive components to be reproduced. The distribution apparatus 300a′ also distributes meta-information associated with each program using a broadcast wave.

(About Meta-Information)

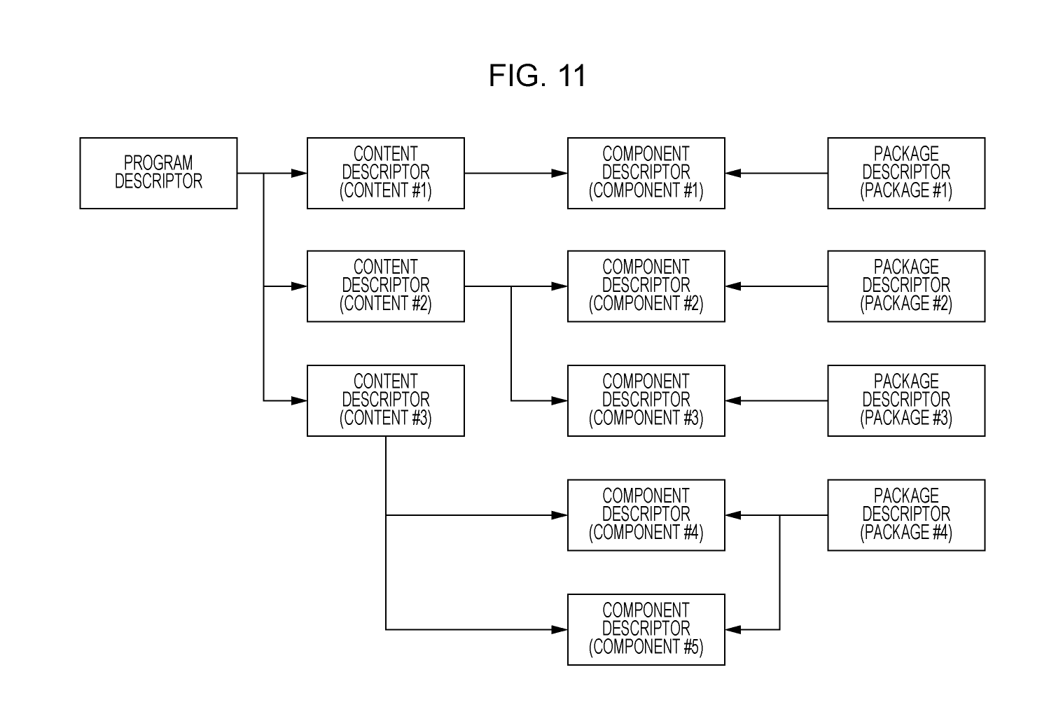

Meta-information referred to by the reproduction apparatus 100′ to reproduce a program is described below in detail with reference to FIG. 11 to FIG. 14.

FIG. 11 is a diagram illustrating an example of a set of packages in which meta-information is described.

As illustrated in FIG. 11, the meta-information includes one program descriptor, one or more content descriptors, one or more component descriptors, and one or more package descriptors.

The program descriptor is a descriptor representing what contents a program includes. In the example illustrated in FIG. 11, the program descriptor indicates that a program includes three contents, that is, a content #1 to a content #3. The program descriptor may include information indicating whether each content is a content essentially required to be reproduced or a content optional as to whether to be reproduced.

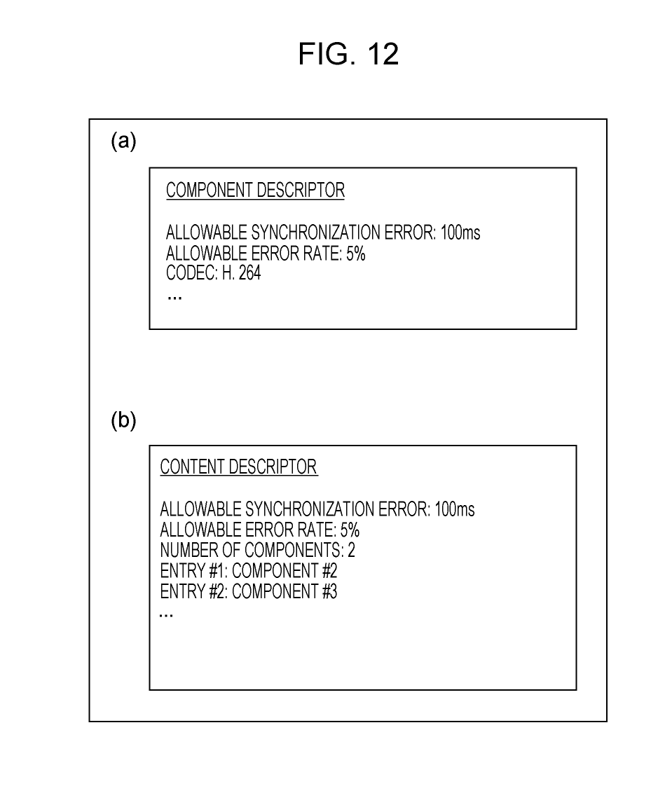

The content descriptor is a descriptor representing what components a content includes. The content descriptor may include information indicating whether each component is a component essentially required to be reproduced or a component optional as to whether to be reproduced. In the example illustrated in FIG. 11, a content descriptor of a content #2 indicates that the content #2 includes two components, that is, a component #2 and a component #3. A specific example of a content descriptor is illustrated in FIG. 12(b).

As illustrated in FIG. 12(b), the content descriptor includes an allowable synchronization error, an allowable error rate, the number of components included in a content, and identifiers of the components included in the content. The “allowable error rate e” is an allowable error rate defined by a broadcast organization for each content. In the distribution system according to the first embodiment, the necessary buffering time D is determined based on the allowable error rate determined by the reproduction apparatus regardless of the type of the content. On the other hand, in the distribution system according to the present embodiment, the necessary buffering time D is determined based on the allowable error rate defined by the broadcast organization for each content. Therefore, if the broadcast organization sets allowable error rates e such that small allowable error rates e are assigned to contents whose reproduction quality is fatally degraded by a data loss as is the case with BML contents, while large allowable error rates e are assigned to contents whose reproduction quality can be maintained at a certain level even when a relatively large amount of data loss occurs as is the case with video contents, then it becomes possible for the reproduction apparatus to obtain the more optimally determined necessary buffering time D.

The “allowable synchronization error” indicates a maximum synchronization error (a maximum reproduction delay of a content of interest with respect to a reference time) allowable when the content of interest is reproduced simultaneously together with another content of a program to be reproduced. In the example illustrated in FIG. 12(b), when a content of interest is reproduced, a reproduction delay of the content of interest is allowed up to 100 msec with respect to the reference time. For example, in the case of BML contents, precise synchronization with a video content is not required, and thus it is allowed to set the allowable synchronization error for BML contents to a relatively large value.

The component descriptor includes, as illustrated in FIG. 12(a), an allowable synchronization error, an allowable error rate, and a codec. The “allowable error rate e” indicates an allowable error rate of a component of interest, and the allowable error rate e is described in a case where different allowable error rates are set for respective components of the content.

On the other hand, the “allowable synchronization error” indicates a maximum synchronization error allowable when the component of interest is reproduced simultaneously together with another component of a program of interest, and the allowable synchronization error is described in a case where different allowable synchronization errors are set for respective components of the content. The “codec” indicates a video image codec or an audio codec in a case where a component is a video image or a sound.

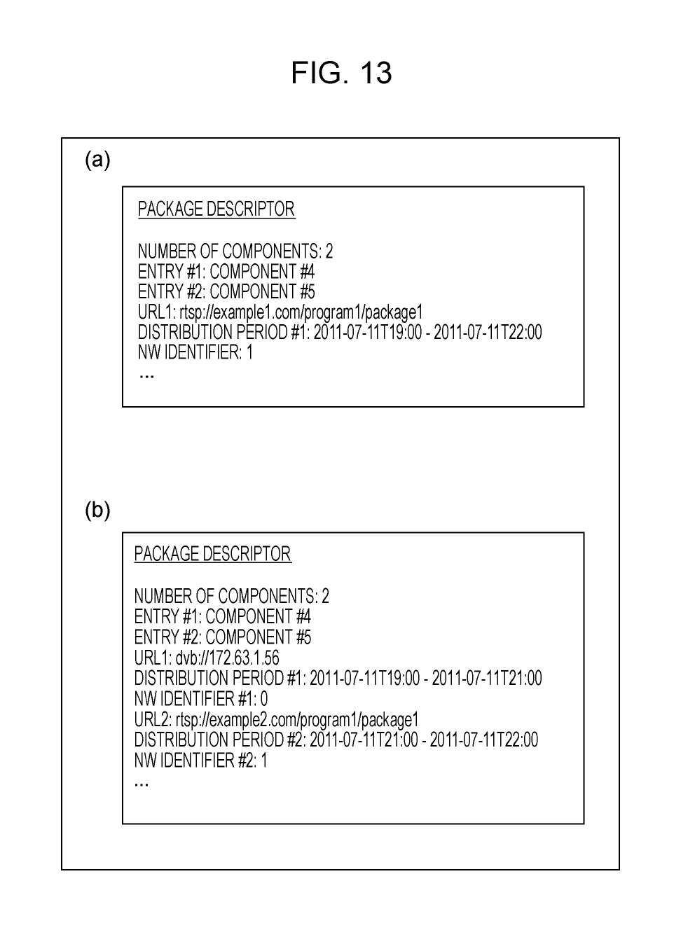

The package descriptor is a descriptor indicating components included in a package. Specific examples of package descriptors are illustrated in FIG. 13(a) and FIG. 13(b).

As illustrated in FIG. 13(a) and FIG. 13(b), the package descriptor includes the number of components included in the package, and identifiers of components included in the package. The package descriptor further includes one or more sets of information including a distribution period during which each components are distributed, access destination information (URL) for acquiring the components in the distribution period, and a NW identifier, which are related to each other.

The NW identifier is explained below with reference to FIG. 14(a) and FIG. 14(b).

FIG. 14(a) illustrates values that are allowed be taken by the NW identifier. As can be seen from FIG. 14(a), the NW identifier is allowed to take eight values from 0 to 7. The NW identifier can be classified into a NW identifier assigned to a distribution apparatus shared by a plurality of broadcast stations (broadcast organizations) and a NW identifier assigned to a distribution apparatus used by a particular broadcast station. Hereinafter, the former identifier is referred to as an identifier of Global Class, and the latter identifier is referred to as an identifier of Local Class. In the present embodiment, four identifiers having a value in a range from 0 to 3 are of Global Class, while four identifiers having a value in a range from 4 to 7 are of Local Class.

FIG. 14(b) illustrates a specific example of a content of the transmission delay history table 155′, which is updated by the streaming control unit 110′ when a package is acquired, and which is referred to by the reproduction unit 120′ to determine the necessary buffering time D.

As illustrated in FIG. 14(b), the transmission delay history table 155′ holds a transmission delay that occurred in the past for each NW identifier of Global Class, and holds a transmission delay for each combination of a NW identifier of Local Class and a broadcast station.

The meta-information, which is referred to by the reproduction apparatus 100′ to reproduce a program, has been described in detail above. Next, a description is given below as to an operation performed before the reproduction apparatus 100′ starts reproducing a program after receiving a program reproduction command.

First, based on the program descriptor and the content descriptor, the streaming control unit 110′ selects a content and a component essentially required to be reproduced. In addition, based on the contents of the reproduction command given by a user, the streaming control unit 110′ determines a component to be reproduced from contents and components that are optional as to whether to be reproduced.

Next, the streaming control unit 110′ refers to each package descriptor to recognize which package each determined component belongs to.

Thereafter, the streaming control unit 110′ refers to URL described in the package descriptor of each package including at least one of components to be reproduced, and the streaming control unit 110′ acquires the package. For example, in a case where the package descriptor is that illustrated in FIG. 13(a) and the current time is within the distribution period #1, then the streaming control unit 110′ accesses a distribution apparatus whose URL is given by rtsp://examp11.com/program1/package1/ and acquires the package therefrom.

The streaming control unit 110′ records the difference between a reception time at which the package was received and a time stamp (distribution time) described in the package as a transmission delay in the transmission delay history table 155′. More specifically, the streaming control unit 110′ refers to a NW identifier related to the URL referred to in acquiring the package, and the streaming control unit 110′ describes the transmission delay in a record, corresponding to the NW identifier referred to, of the transmission delay history table 155′.

The reproduction unit 120′ refers to the NW identifier described in the package descriptor of each package to be acquired and also refers to the transmission delay recorded in the past in the record, corresponding to the NW identifier referred to, of the transmission delay history table 155′, and the reproduction unit 120′ determines the necessary buffering time D for the component included in each package.

More specifically, to determine the necessary buffering time for the components included in the package, the reproduction unit 120′ refers to the allowable synchronization error and the allowable error rate described in the component descriptor of each component included in the package and refers to the allowable synchronization error and the allowable error rate described in the content descriptor of each content including at least one of components included in the package. In the example illustrated in FIG. 11, when the necessary buffering time D is determined for the component #4 included in the package #4, if the component descriptor of the component #4 includes a description of an allowable error rate and an allowable synchronization error, then the reproduction unit 120′ selects the allowable error rate and the allowable synchronization error as values used to determine the necessary buffering time D. On the other hand, if the component descriptor of the component #4 does not include a description of an allowable error rate and an allowable synchronization error, then the reproduction unit 120′ selects the allowable error rate and the allowable synchronization error described in the content descriptor of the content #3 as values to determine the necessary buffering time D.

The reproduction unit 120′ then determines the necessary buffering time D depending on the selected allowable error rate e and allowable synchronization error Td.

For example, when the reproduction unit 120′ reproduces a package, as with the reproduction unit 120 of the reproduction apparatus 100, the reproduction unit 120′ may set the necessary buffering time D based on the allowable error rate e such that a delay time corresponding to an entry in a range of e % of delay times from the largest value recorded in corresponding records of the transmission delay history table 155′ is employed as the necessary buffering time D. By setting the necessary buffering time D in the above-described manner, it becomes possible for the reproduction apparatus 100′ to complete the reception of 100-e % of data in the buffering period before the start of reproduction, and it is expected to maintain the particular reproduction quality even if the reproduction is performed without waiting for the remaining 5% of data to be completely received and thus without using the 5% of data.

Alternatively, the reproduction unit 120′ may select 100 delay times randomly from a sufficiently large number of delay times recorded in corresponding records of the transmission delay history table 155′, and may employ an e-th greatest one of the selected delay times as the necessary buffering time D thereby achieving a similar advantageous effect.

Still alternatively, when the necessary buffering time determined based on the above-described allowable error rate e is denoted by D′, the necessary buffering time D for a component of interest may be given using the allowable synchronization error Td as D=D′−Td, which is smaller than the above value of the necessary buffering time. In the case where the necessary buffering time D is given by D′−Td, it is not allowed to receive, in this buffering period, 100-e % of data required to achieve the predetermined quality in the reproduction. Therefore, in this case, the reproduction may be performed such that the timing of reproducing the component of interest is delayed up to Td with reference to the reference time thereby ensuring that the buffering time becomes as large as D′ necessary to reproduce the component. By determining the necessary buffering time in the above-described manner, it becomes possible to suppress an influence of the necessary buffering time on the delay in the start of reproduction of the program of interest to be reproduced, and more specifically, the contents of components with relatively large allowable synchronization errors such as BML contents, sub title components, or the like.

Alternatively, the reproduction unit 120′ may set D to a value obtained by subtracting the allowable synchronization error Td from a greatest delay time recorded in the corresponding records times (100−e)/100.

The operation performed by the reproduction apparatus 100′ after the necessary buffering time D is determined for each package is similar to that of the reproduction apparatus 100 according to the first embodiment, and thus a further description thereof is omitted.

(Advantages of Reproduction Apparatus 100′)

The operation of the reproduction apparatus 100′ has been described above. As can be seen from FIG. 14(b), the transmission delay history table 155′ referred to by the reproduction apparatus 100′ to determine the necessary buffering time D includes as many records as at most 4+4× the number of broadcast stations. In the distribution system according to the present embodiment, any of all distribution apparatuses is included in one of groups (that is, is assigned one of NW identifiers), and thus the number of records is constant regardless of the number of distribution apparatuses included in the distribution system.

Therefore, the constancy of the number of records allows the reproduction apparatus 100′ to easily manage the transmission delay history table compared with the reproduction apparatus 100 configured to record transmission delays such that a transmission delay of each distribution apparatus is recorded in a different record in the transmission delay history table 155.

In CDN distribution systems, as the number of users of distribution service increases, new distribution apparatuses are generally added. In the distribution system according to the present embodiment, a distribution apparatus newly added to the distribution system is assigned one of NW identifiers. Therefore, even in a case where the reproduction apparatus 100′ receives a package from the newly added distribution apparatus, the reproduction apparatus 100′ is capable of properly determining the necessary buffering time D based on past transmission delays.

In the present embodiment, distribution apparatuses are grouped according to transmission networks via which programs are transmitted. However, the manner of grouping the distribution apparatuses is not limited to this. Instead, distribution apparatuses may be grouped according to areas (nations, districts, or the like) in which distribution apparatuses are installed.

In the embodiments described above, it is assumed, by way of example but not limitation, that each reproduction apparatus records a history of transmission delays referred to by a reproduction apparatus to determine the necessary buffering time D. Alternatively, for example, another apparatus (for example, a proxy server, a router, or the like for a reproduction apparatus) may be disposed between a reproduction apparatus and a distribution apparatus and a history of transmission delays may be recorded in this apparatus. In this case, the reproduction apparatus may refer to transmission delays recorded in the apparatus to determine the necessary buffering time D.

(Program and Storage Medium)

Each block of the reproduction apparatus 100 may be realized by hardware using a logic circuit formed in an integrated circuit (on an IC chip) or may be realized by software using a CPU (Central Processing Unit).

In the latter case, the reproduction apparatus 100 includes a CPU that executes a program to realize various functions, a ROM (Read Only Memory) storing the program, a RAM (Random Access Memory) in which the program is loaded, a storage apparatus (storage medium) such as a memory that stores the program and various kinds of data, and the like. The purpose of the present invention may also be achieved by storing program codes (an executable program, an intermediate code program, a source program) of a control program of the reproduction apparatus 100 as software for realizing the above-described functions in a computer-readable storage medium, supplying the storage medium to the reproduction apparatus 100, and reading and executing the program stored in the storage medium by a computer (or a CPU, a MPU, or the like) in the reproduction apparatus 100.

Examples usable as the above-described storage medium include tapes such as a magnetic tape, a cassette tape, and the like, magnetic disks such as a floppy (registered trademark) disk/hard disk and the like, disks including optical disks such as CD-ROM/MO/MD/DVD/CD-R and the like, cards such as an IC card (including a memory card)/optical card and the like, semiconductor memories such as a mask ROM/EPROM/EEPROM (registered trademark)/flash ROM and the like, and logic circuits such as a PLD (Programmable logic device), FPGA (Field Programmable Gate Array), and the like.

Alternatively, the program code may be supplied to the reproduction apparatus 100 via a communication network. There is no particular restriction on the communication network as long as the communication network is capable of transmitting program codes. Examples usable as the communication network include the Internet, an intranet, an extranet, a LAN, an ISDN, a VAN, a CATV communication network, a virtual private network, a telephone network, a mobile communication network, a satellite communication network, and the like. There is no restriction in terms of structure or type on a transmission medium in the communication network as long as the medium is capable of transmitting program codes. Examples usable as the transmission medium include a wired medium such as IEEE1394, USB, a power-line carrier, a cable TV line, a telephone line, ADSL (Asymmetric Digital Subscriber Line), and the like, and a wireless medium such as an infrared medium such as IrDA, a remote control, and the like, Bluetooth (registered trademark), an IEEE802.11 wireless medium, HDR (High Data Rate), NFC (Near Field Communication), a DLNA (Digital Living Network Alliance), a portable telephone network, a satellite communication line, a digital terrestrial network, and the like.

Note that the embodiments described above are all provided merely by way of example and not limitation. The present invention is not limited to the embodiments described above but only by the claims, and many changes are possible without departing from the spirit and the scope of the invention as defined in the claims.

As described above, the reproduction apparatus according to the present invention may preferably further include selection means that selects whether or not component data that can be a constituent element of the distribution data is to be acquired as part of the set of pieces of component data by the acquisition means, wherein in a case where the delay time recorded as the history of the distribution apparatus that distributes the component data is not greater than a particular allowable time, the selection means makes the acquisition means acquire the component data.

In this configuration, the reproduction apparatus performs reproduction by acquiring, from each distribution apparatus, only component data capable of being reproduced within the particular allowable time. Thus, the reproduction data is capable of reproducing distribution data that is not allowed to be late in reproduction by an amount longer than the particular allowable time such that the distribution data is reproduced within the particular allowable time.

The reproduction apparatus may preferably further include storage means that stores the distribution data in a storage medium, wherein the setting means is configured to set the particular allowable time, and in a case where the storage means stores the distribution data in the storage medium, the setting means sets the particular allowable time to be longer than in a case where the distribution data is not stored in the storage medium.

Preferably, in the reproduction apparatus according to the present invention, in a case where the component data is included in the distribution data and is essentially required to be reproduced, the selection means makes the acquisition means acquire the component data regardless of the particular allowable time.

Preferably, in the reproduction apparatus according to the present invention, the distribution data is scalable data including a predetermined number of layers of hierarchical data, the selection means is configured to, after a particular period has elapsed from a point of time at which the reproduction means started reproducing the distribution data, further select hierarchical data from a distribution apparatus whose delay time is greater than the particular allowable time, and the reproduction means is configured to reproduce the distribution data at a speed lower than a standard reproduction speed until the particular period has elapsed.

In the configuration described above, by setting the particular period such that after the particular period has elapsed, it becomes possible to synchronously reproduce all pieces of hierarchical data, it is possible to achieve a further advantageous effect that the reproduction apparatus is capable of reproducing all pieces of hierarchical data after the particular period has elapsed regardless of the particular allowable time.

Preferably, in the reproduction apparatus according to the present invention, the referring means is configured to refer to a delay time for each of a plurality of groups of distribution apparatuses, each group including at least one of the plurality of distribution apparatuses, each distribution apparatus belonging to one of the plurality of groups, the delay time indicating a delay time that occurred when component data was acquired in the past from a distribution apparatus belonging to one of the plurality of groups and that is recorded in the storage medium as a history of the group and the derivation means is configured to, for each of the plurality of groups, derive a period as a buffering period needed to reproduce component data acquired from the distribution apparatus belonging to one of the plurality of groups such that the period has a length depending on a magnitude of the delay time recorded as the history of the group and referred to by the referring means.

In this configuration, the reproduction apparatus determines the particular period, which is the buffering period before the reproduction is started, by referring to a transmission delay recorded for each group of one or more distribution apparatuses. Therefore, in a case where the reproduction apparatus has acquired component data from a distribution apparatus belonging to a certain group, the reproduction apparatus is capable of properly determining the buffering period when the reproduction apparatus acquires component data for the first time from another distribution apparatus belonging to the same group.

To achieve the advantageous effects described above, the reproduction apparatus according to the present invention may include acquisition means that acquires a set of pieces of component data distributed from respective ones of a plurality of distribution apparatuses, the pieces of component data being components of distribution data and being to be synchronously reproduced, referring means configured to refer to a delay time for each of a plurality of groups of distribution apparatuses, each group including at least one of the plurality of distribution apparatuses, each distribution apparatus belonging to one of the plurality of groups, the delay time indicating a delay time that occurred when component data was acquired in the past from a distribution apparatus belonging to one of the plurality of groups and that is recorded in a storage medium as a history of the group, derivation means configured to, for each of the plurality of groups, derive a period as a buffering period needed to reproduce component data acquired from the distribution apparatus belonging to one of the plurality of groups such that the period has a length depending on a magnitude of the delay time recorded as the history of the group and referred to by the referring means, reproduction means that reproduces the distribution data after component data being acquired from each one of the plurality of distribution apparatuses has been buffered for a particular period, and setting means that sets the particular period so as to be equal to a greatest one of the buffering periods derived by the derivation means.

Preferably, the reproduction apparatus may further include history storage means that stores in the storage medium a delay time for each of the plurality of groups, the delay time indicating a delay time that occurred when component data was acquired from a distribution apparatus belong to one of the plurality of groups and that is stored as a history of the group.

Preferably, the reproduction apparatus according to the present invention further includes reception means that receives meta-information from the outside of the reproduction apparatus, the meta-information indicating at least one of an allowable error rate and an allowable synchronization error allowed in reproducing component data, the allowable synchronization error indicating an allowable error in terms of synchronization with respect to another component data, wherein the buffering period derived by the derivation means for each one of the plurality of groups is equal to a value obtained by subtracting a magnitude of at least one of the allowable synchronization error and the allowable error rate indicated by the meta-information as to component data received from a distribution apparatus belonging to the group from a greatest value of delay times that are recorded as a history of the group and referred to by the referring means.

The present invention also provides a distribution apparatus configured to transmit, in addition to the component data, meta-information indicating at least of an allowable synchronization error and an allowable error rate for the component data to the reproduction apparatus.

The present invention also provides a distribution system comprising the reproduction apparatus according to the invention and a plurality of distribution apparatuses. In the distribution system, the plurality of distribution apparatuses may be managed by a broadcast organization, and the distribution system may further comprise a notification apparatus managed by the broadcast organization and configured to notify the reproduction apparatus of meta-information indicating URL of a distribution apparatus and a group to which the distribution apparatus belongs to, for each of the plurality of distribution apparatuses.

The present invention also provides a program that causes a computer to operate as the reproduction apparatus according to the present invention wherein the program is configured to cause the computer to function as said means, and a computer-readable storage medium storing such a program also fall within the scope of the present invention.

### INDUSTRIAL APPLICABILITY

The reproduction apparatus according to the present invention may be used in a wide variety of applications such as a smart television set, a smartphone, a content distribution system, and the like.

### REFERENCE SIGNS LIST

100, 100′ reproduction apparatus
110, 110′ streaming control unit [acquisition means, storage means, history storage means, reproduction means]
120, 120′ reproduction unit [referring means, setting means, reproduction means, selection means]
130 reception buffer
140 HDD (hard disk drive) [storage medium]
150, 150′ memory [storage medium]
155 transmission delay history database
160 network I/F
170 tuner unit
200 display apparatus
300a to 300c distribution apparatus
300a′ distribution apparatus (notification apparatus)

1. A reproduction apparatus comprising:
acquisition means that acquires a set of pieces of component data distributed from respective ones of a plurality of distribution apparatuses, the pieces of component data being components of distribution data and being to be synchronously reproduced;
referring means that refers, for each one of the plurality of distribution apparatuses, to a delay time that occurred when component data was acquired in the past from the distribution apparatuses, the delay time being stored in a storage medium as a history of the distribution apparatuses;
derivation means that derives, for each of the plurality of distribution apparatuses, a buffering period necessary in reproducing component data acquired from the distribution apparatus such that the buffering period has a length corresponding to a magnitude of the delay time stored as the history of the distribution apparatus and referred to by the referring means;
reproduction means that reproduces the distribution data after component data being acquired from each one of the plurality of distribution apparatuses has been buffered for a particular period; and
setting means that sets the particular period so as to be equal to a greatest one of the buffering periods derived by the derivation means.

2. The reproduction apparatus according to claim 1, further comprising selection means that selects whether or not component data that can be a constituent element of the distribution data is to be acquired as part of the set of pieces of component data by the acquisition means,
wherein in a case where the delay time recorded as the history of the distribution apparatus that distributes the component data is not greater than a particular allowable time, the selection means makes the acquisition means acquire the component data.

3. The reproduction apparatus according to claim 2, further comprising storage means that stores the distribution data in a storage medium,
wherein the setting means is configured to set the particular allowable time, and
in a case where the storage means stores the distribution data in the storage medium, the setting means sets the particular allowable time to be longer than in a case where the distribution data is not stored in the storage medium.

4. The reproduction apparatus according to claim 2, wherein in a case where the component data is included in the distribution data and is essentially required to be reproduced, the selection means makes the acquisition means acquire the component data regardless of the particular allowable time.

5. The reproduction apparatus according to claim 2, wherein
the distribution data is scalable data including a predetermined number of layers of hierarchical data,
the selection means is configured to, after a particular reproduction period has elapsed from a point of time at which the reproduction means started reproducing the distribution data, further select hierarchical data from a distribution apparatus whose delay time is greater than the particular allowable time,
the reproduction means is configured to reproduce the distribution data at a speed lower than a standard reproduction speed until the particular reproduction period has elapsed, and
the particular reproduction period is a period that allows it to synchronously reproduce all hierarchical data at the standard reproduction speed when the particular reproduction period has elapsed.

6. The reproduction apparatus according to claim 1, wherein
the referring means is configured to refer to a delay time for each of a plurality of groups of distribution apparatuses, each group including at least one of the plurality of distribution apparatuses, each distribution apparatus belonging to one of the plurality of groups, the delay time indicating a delay time that occurred when component data was acquired in the past from a distribution apparatus belonging to one of the plurality of groups and that is recorded in the storage medium as a history of the group and
the derivation means is configured to, for each of the plurality of groups, to derive a period as a buffering period needed to reproduce component data acquired from the distribution apparatus belonging to one of the plurality of groups such that the period has a length depending on a magnitude of the delay time recorded as the history of the group and referred to by the referring means.

7. A reproduction apparatus comprising:
acquisition means that acquires a set of pieces of component data distributed from respective ones of a plurality of distribution apparatuses, the pieces of component data being components of distribution data and being to be synchronously reproduced;
referring means configured to refer to a delay time for each of a plurality of groups of distribution apparatuses, each group including at least one of the plurality of distribution apparatuses, each distribution apparatus belonging to one of the plurality of groups, the delay time indicating a delay time that occurred when component data was acquired in the past from a distribution apparatus belonging to one of the plurality of groups and that is recorded in a storage medium as a history of the group;
derivation means configured to, for each of the plurality of groups, derive a period as a buffering period needed to reproduce component data acquired from the distribution apparatus belonging to one of the plurality of groups such that the period has a length depending on a magnitude of the delay time recorded as the history of the group and referred to by the referring means;
reproduction means that reproduces the distribution data after component data being acquired from each one of the plurality of distribution apparatuses has been buffered for a particular period; and
setting means that sets the particular period so as to be equal to a greatest one of the buffering periods derived by the derivation means.

8. The reproduction apparatus according to claim 7, further comprising history storage means that stores in the storage medium a delay time for each of the plurality of groups, the delay time indicating a delay time that occurred when component data was acquired from a distribution apparatus belong to one of the plurality of groups and that is stored as a history of the group.

9. The reproduction apparatus according to claim 7, further comprising reception means that receives meta-information from the outside of the reproduction apparatus, the meta-information indicating at least one of an allowable error rate and an allowable synchronization error allowed in reproducing component data, the allowable synchronization error indicating an allowable error in terms of synchronization with respect to another component data,
wherein the buffering period derived by the derivation means for each one of the plurality of groups is equal to a value obtained by subtracting a magnitude of at least one of the allowable synchronization error and the allowable error rate indicated by the meta-information as to component data received from a distribution apparatus belonging to the group from a greatest value of delay times that are recorded as a history of the group and referred to by the referring means.

10. A distribution apparatus configured to transmit, in addition to the component data, meta-information indicating at least of an allowable synchronization error and an allowable error rate for the component data to the reproduction apparatus according to claim 9.

11. A distribution system comprising the reproduction apparatus according to claim 1, and a plurality of distribution apparatuses.

12. A distribution system comprising:
the reproduction apparatus according to claim 7; and
a plurality of distribution apparatuses;
the plurality of distribution apparatuses being managed by a broadcast organization,
the distribution system further comprising a notification apparatus managed by the broadcast organization and configured to notify the reproduction apparatus of meta-information indicating URL of a distribution apparatus and a group to which the distribution apparatus belongs to, for each of the plurality of distribution apparatuses.

13. A reproduction method comprising:
acquiring a set of pieces of component data distributed from respective ones of a plurality of distribution apparatuses, the pieces of component data being components of distribution data and being to be synchronously reproduced;
referring, for each one of the plurality of distribution apparatuses, to a delay time that occurred when component data was acquired in the past from the distribution apparatus, the delay time being stored in a storage medium as a history of the distribution apparatus;
deriving, for each of the plurality of distribution apparatuses, a buffering period necessary in reproducing component data acquired from the distribution apparatus such that the buffering period has a length corresponding to a magnitude of the delay time stored as the history of the distribution apparatus and referred to;
reproducing the distribution data after a content being acquired from each one of the plurality of distribution apparatuses has been buffered for a particular period; and
setting the particular period so as to be equal to a greatest one of the derived buffering periods.

14. A reproduction program that causes a computer to operate as the reproduction apparatus according to claim 1, the reproduction program being configured to cause the computer to function as said means.

15. A computer-readable storage medium storing the reproduction program according to claim 14.
